(19) United States
(12) Patent Application Publication
(10) Pub. No.: US 2026/0340789 A1
(43) Pub. Date: Oct. 29, 2026

(54) METHOD AND DEVICE FOR LOCALITY-AWARE FIELD-BASED THERMAL IMAGE ENHANCEMENT

(71) Applicants: Seoul National University R&DB Foundation, Seoul (KR); KOREA ELECTRONICS TECHNOLOGY INSTITUTE, Seongnam-si (KR)

(72) Inventors: Ayoung Kim, Seoul (KR); Hyeonjae Gil, Seoul (KR); Myunghwan Jeon, Seoul (KR); Chungjae Choe, Seongnam-si, Gyeonggi-do (KR)

(21) Appl. No.: 19/643,678

(22) Filed: Apr. 9, 2026

(30) Foreign Application Priority Data
Apr. 23, 2025 (KR) 10-2025-0052952

(51) Int. Cl. G06T 5/73; G06T 3/4007

(52) U.S. Cl. CPC G06T 5/73; G06T 3/4007; G06T 2207/10048; G06T 2207/20021

(57) ABSTRACT

The present disclosure relates to a method and device for locality-aware field-based thermal image enhancement, and may be configured to construct a two-dimensional field from a local heat distribution of a thermal image having a first pixel depth, and convert the thermal image into a thermal image having a second pixel depth smaller than the first pixel depth using the two-dimensional field.

### CROSS-REFERENCE TO RELATED APPLICATION

This application claims priority under 35 U.S.C § 119 to Korean Patent Application No. 10-2025-0052952 filed in the Korean Intellectual Property Office on Apr. 23, 2025, the entire contents of which are hereby incorporated by reference.

### BACKGROUND OF THE INVENTION

### Field of the Invention

The present disclosure relates to a thermal image processing technique, and more particularly, to a technique of converting a raw thermal image (thermal infrared; TIR) into a high-quality image considering locality that represents spatial characteristics.

### Background of the Related Art

Thermal imaging cameras are emerging as promising sensors in the safety-related field owing to their robustness against external lighting. However, raw thermal images have a pixel depth of 14 or 16 bits and should be rescaled to 8 bits for general applications. Previous studies have calculated pixel-unit gains based only on intensity by utilizing a global one-dimensional lookup table (LUT), and this degrades image quality as thermal locality is not considered. More specifically, conventional methods convert raw thermal images from 14 or 16 bits to 8 bits using a global one-dimensional transfer function (e.g., linear AGC (automatic gain control), histogram equalization, etc.). Since local temperature differences are not reflected sufficiently, this method has a problem of lowering global contrast and generating loss of details when there is a strong localized heat source.

Meanwhile, this application is supported by the national research and development project described below.

Project Unique ID: 2710100581

Project ID: 11220480

Ministry Name: Ministry of Science and ICT

Title of Project Management (Specialized) Organization: Institute of Information & Communication Technology Planning & Evaluation

Title of Research Business: Development (R&D) of human-centered AI core source technology

Title of Research Project: Development of goal-oriented AI generation and inference technology

Title of Project Implementing Organization: Seoul National University R & DB Foundation

Research Period: Jan. 1, 2024~Dec. 31, 2026

National research and development projects that have supported this invention.

Project Unique Number: 2710100525

Project Number: 00461409

Ministry Name: Ministry of Science and ICT

Title of Project Management (Specialized) Organization: National Research Foundation (NRF) of Korea

Title of Research Business: Development (R&D) of future pioneering convergence science and technology

Title of Research Project: Development of harmonic-space configuration and operation technology based on seamless information sharing of hyperscale unmanned vehicles

Title of Project Implementing Organization: Korea Electronics Technology Institute

Research Period: Jan. 1, 2025~Dec. 31, 2026

### SUMMARY OF THE INVENTION

Therefore, the present disclosure has been made in view of the above problems, and it is an object of the present disclosure to obtain a high-quality 8-bit image while preserving local characteristics of a raw thermal image as much as possible by constructing a two-dimensional scalar field.

The present disclosure provides a method and device for locality-aware field-based thermal image enhancement.

To accomplish the above object, according to one aspect of the present invention, there is provided an operation method of a computer device for locality-aware field-based thermal image enhancement, the method comprising the steps of: constructing a two-dimensional field from a local heat distribution of a thermal image having a first pixel depth; and converting the thermal image into a thermal image having a second pixel depth smaller than the first pixel depth using the two-dimensional field.

According to the present disclosure, a computer device for locality-aware field-based thermal image enhancement, the device may comprise: a memory; and a processor connected to the memory and configured to execute at least one instruction stored in the memory, wherein the processor may be configured to construct a two-dimensional field from a local heat distribution of a thermal image having a first pixel depth, and convert the thermal image into a thermal image having a second pixel depth smaller than the first pixel depth using the two-dimensional field.

According to the present disclosure, in a computer program stored in a non-transitory computer-readable recording medium to execute a locality-aware field-based thermal image enhancement method on a computer device, the thermal image enhancement method may comprise the steps of: constructing a two-dimensional field from a local heat distribution of a thermal image having a first pixel depth; and converting the thermal image into a thermal image having a second pixel depth smaller than the first pixel depth using the two-dimensional field.

### BRIEF DESCRIPTION OF THE DRAWINGS

FIG. 1 is a view showing reconstruction of a one-dimensional transfer function-based problem into a two-dimensional field-based problem according to the present disclosure.

FIG. 2 is a view showing a pipeline for locality-aware field-based thermal image enhancement according to the present disclosure.

FIG. 3 is a view showing the results of qualitatively assessing locality-aware field-based thermal image enhancement according to the present disclosure.

FIG. 4 is a view showing the results of quantitatively assessing locality-aware field-based thermal image enhancement according to the present disclosure.

FIG. 5 is a view showing a computer device for locality-aware field-based thermal image enhancement according to the present disclosure.

FIG. 6 is a flowchart illustrating an operation method of a computer device for locality-aware field-based thermal image enhancement according to the present disclosure.

### DETAILED DESCRIPTION OF THE PREFERRED EMBODIMENT

The present disclosure provides a method and device for locality-aware field-based thermal image enhancement.

Specifically, the present disclosure proposes Fieldscale, which is a 2D field-based rescaling method for thermal images having high spatial temperature variation. The Fieldscale utilizes two scalar fields, and each field corresponds to the image size and includes local information of each area. The core concept thereof is formulating field configuration as a problem of graph configuration and using information on each image area as a node. In addition, it generates spatially consistent and natural images by utilizing the message passing method of a graph neural network (GNN). Therefore, the Fieldscale may adaptively determine the gain of each pixel appropriate for spatial distribution of temperature. This may generate images with maximized contrast, rich details, and minimal information loss, regardless of the temperature or size of objects. The Fieldscale may improve performance of subsequent tasks that rely on image quality or detailed local information. The contents of the present disclosure may be summarized as follows.

The Fieldscale is a locality-aware 14-bit or 16-bit to 8-bit thermal image rescaling methodology for adjusting the gain of each pixel according to spatial context. This method preserves local radiation measurements, fine details, global context, and spatial consistency. It can be utilized in various applications ranging from visualization to safety-related tasks owing to single-shot and real-time operation functions.

The Fieldscale is featured by a simplified field configuration process having minimal sensitive parameters. It allows each component to be easily customized to meet specific requirements through a modular design. In addition, as the quality can be enhanced by integrating additional image enhancement functions, the Fieldscale can be a scalable alternative compared to previous methods based on one-dimensional lookup table.

The effect of the Fieldscale has been proven through excellent results in the image quality assessment metrics. In addition, it has been thoroughly validated in various downstream applications, such as visual location recognition and object detection. The entire codebase is provided as open source to accelerate future research on thermal imaging in robotics.

Hereinafter, various embodiments of this document will be described with reference to the accompanying drawings.

The core technical means for achieving the objects or effects of the present invention are divided into two categories described below.

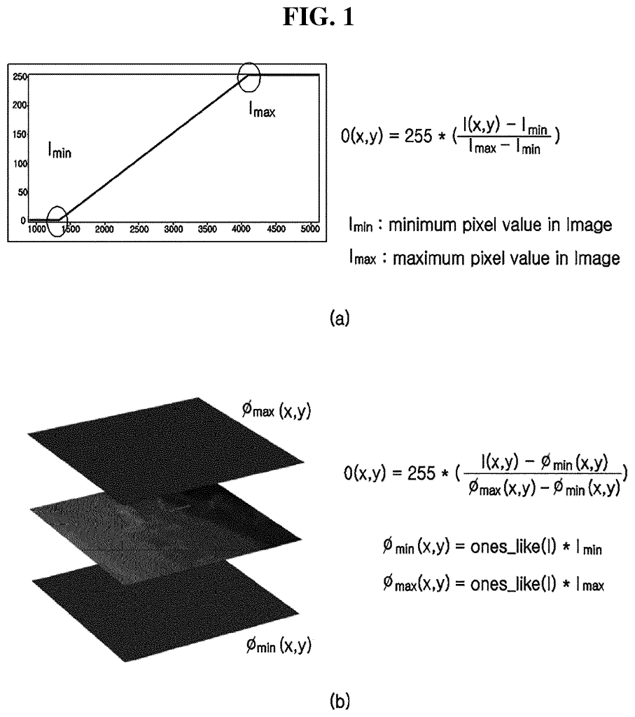

The first one is reconstruction of an existing global one-dimensional transfer function-based problem into a two-dimensional field-based problem. FIG. 1 is a view showing reconstruction of a one-dimensional transfer function-based problem into a two-dimensional field-based problem according to the present disclosure. Here, FIG. 1(a) shows a one-dimensional transfer function problem, and FIG. 1(b) shows a two-dimensional field-based problem. According to the one-dimensional transfer function problem shown in FIG. 1(a), the same conversion reference value is applied to all pixels. Therefore, it is difficult to reflect locality of a thermal image using a one-dimensional global lookup table. Meanwhile, as the present disclosure replaces a one-dimensional transfer function with a two-dimensional scalar field as shown in FIG. 1(b) so that the conversion reference value varies according to the spatial context of pixels, pixel-unit conversion reflecting local heat distribution may be performed at each location. This fundamentally resolves the structural limitation of distorting the entire image by a strong localized heat source.

The second one is a method of constructing a two-dimensional field considering spatial consistency and preservation of details. When simply the two-dimensional field is constructed, image quality can be degraded due to local outliers or discontinuity between the grids. The present disclosure solves the problems by designing modules of grid-wise min/max pooling for extracting local temperature information; local extrema suppression (LES) for suppressing extreme values; message passing (MP) for securing consistency between fields; and bilinear interpolation for smooth expansion of resolution.

In this way, the present disclosure minimizes information loss by utilizing a two-dimensional field. A two-dimensional field capable of containing spatial thermal information in each area of the image is constructed, and a conversion formula considering the spatial context is applied to each pixel. In this process, 8-bit conversion is performed in a direction of preserving local information to the maximum. Furthermore, the present disclosure is free from prior information/parameter sensitivity of the observation environment. The 8-bit conversion may be performed even without scene-specific information, such as maximum/minimum temperatures or the like within a given environment. Parameters used in the technique of the present disclosure may be set regardless of the observation environment, and parameter sensitivity is as low as the absolute values of the parameters do not significantly affect the conversion result. Owing to the systematic configuration, real-time high-quality conversion is realized, and it has been experimentally proven that information loss is reduced, and recognition performance is improved.

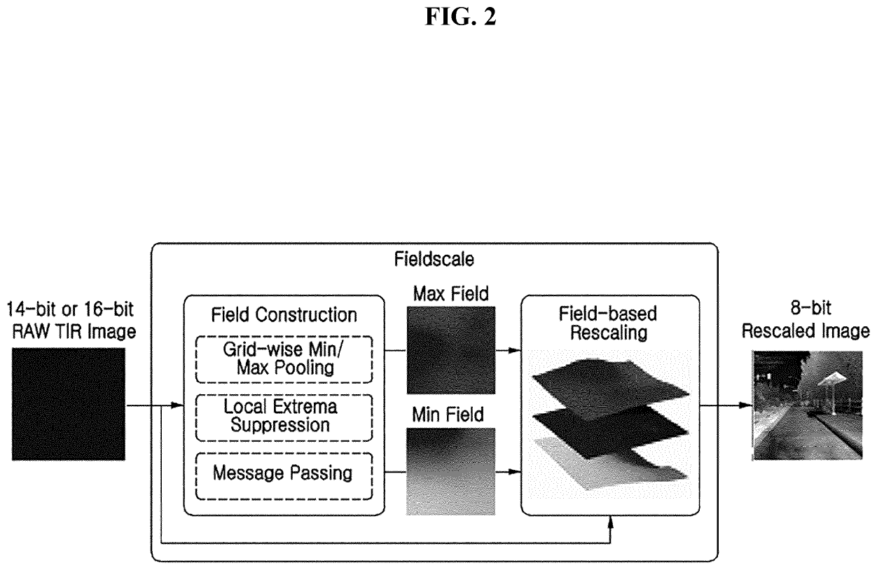

FIG. 2 is a view showing a pipeline for locality-aware field-based thermal image enhancement according to the present disclosure.

Referring to FIG. 2, the pipeline for locality-aware field-based thermal image enhancement goes through the steps described below.

The first step is input of a raw thermal image. A 14-bit or 16-bit raw thermal image captured by a FUR or the like is input.

The second step is grid-wise min/max pooling. The image is divided into uniform grids of a predetermined size, and the maximum (Max) and minimum (Min) values within each grid are extracted to form a “min grid” and a “max grid.”

This offers various advantages of limiting the impact of objects on the patch at an extreme temperature, separating the process of handling hot and cold areas, and faster subsequent processing regardless of the image size. In regard to the grid size, as the grid size decreases, it is more difficult to sufficiently encode local information, and as the grid size increases, consumption of time increases. Therefore, it is empirically found that an 8×8 grid size is suitable for outdoor scenes and also suitable for indoor scenes with a much narrower intensity range.

The third step is local extrema suppression. When the maximum value of each grid is significantly different from the surrounding average value, degradation of quality occurred by local outliers is prevented by correcting the difference through a threshold value.

More specifically, although the minimum and maximum grids may have local minimum and maximum information of each area, when there are very hot or cold objects in the local area, their values may be significantly different from the surrounding environment. According thereto, additional processing is required not to degrade the overall image appearance. As a solution, the entire grid is regarded as a graph G=(V, E) first, and each element of the grid is regarded as a node V, and E is regarded as a set of edges connecting each node to its eight neighboring storage elements. For each node v E V, a neighborhood function N(v, d) of returning a set of nodes within a distance d and an average value thereof A(v, d) is also defined. The local extrema suppression is applied to all nodes in the graph as shown in [Equation 1].

$$LES ( v , d ) = \{ \begin{matrix}A ( v , d ) - {T}_{LES} , & if v < A ( v , d ) - {T}_{LES} \\ A ( v , d ) + {T}_{LES} , & if A ( v , d ) + {T}_{LES} < v \\ v , & otherwise\end{matrix} \qquad [ Equation 1 ]$$

Here, T_{LES} is the threshold value for local extrema suppression. d=2 is fixed for 8×8 grid size. The local extrema suppression may appropriately fix the value of the largest grid, where an object of an extreme temperature is located. Since the minimum grid almost does not experience extrema locally, the local extrema suppression is applied only to the maximum field.

The fourth step is message passing. Information on neighboring areas is exchanged between the grids a plurality of times (N times) to reduce discontinuity along the grid boundaries and complete consistent “min field” and “max field”.

More specifically, inspired by the message passing in the graph neural network (GNN), where adjacent nodes exchange embeddings, the present disclosure proposes a message passing method for min/max grids. This method does not exchange embedding vectors or use a neural network, and each pixel exchanges min/max scalars. In a way similar to the GNN, an aggregation function (Agg) and an update function (Update) are defined as shown below in Equation 2 to update the value of each node.

v^{t+1}=Update(v^{t},Agg(N(v,1))) [Equation 2]

Here, t represents the current iteration of message passing. In the case of aggregation function, a mean operator with a distance of d=1 is used. For the update function, a min(x, y) operator is used to appropriately reduce the value in the case the minimum grid, and a max(x, y) operator is used to increase the value in each iteration in the case of the maximum grid. Although these operators are fixed in this document, they may be easily customized to a specific downstream task.

The fifth step is bilinear interpolation and rescaling. The corrected grid is expanded as much as the original resolution using the bilinear interpolation. 8-bit conversion is performed for each pixel according to Equation 3 shown below. As needed, contrast of the final image may be maximized by applying contrast limited adaptive histogram equalization (CLAHE) or the like to the image after conversion.

$$O ( x , y ) = 255 \times \frac{I ( x , y ) - {∅}_{min} ( x , y )}{{∅}_{max} ( x , y ) - {∅}_{min} ( x , y )} \qquad [ Equation 3 ]$$

Here, I(x,y) represents the input raw thermal image, O(x,y) represents the output 8-bit image, Φₘᵢₙ(x,y) represents the minimum field, and Φₘₐₓ(x,y) represents the maximum field.

More specifically, after the fourth step, the corrected grid is upscaled to a size the same as that of the image using bilinear interpolation. As needed, gamma correction may be applied using γ=1.5 and CLAHE after rescaling to maximize local contrast.

The Fieldscale enriches the overall contrast to the appearance, as well as local details. However, additional image enhancement modules for sharpening, deblurring, or non-uniform bias correction may be considered according to the purposes. Unlike the conventional rescaling of sequentially applying enhancement to 8-bit rescaled images, as the Fieldscale allows the enhancement to be applied in parallel, there is a remarkable advantage in preventing information loss owing to 8-bit quantization. As shown in FIG. 2, raw images are simultaneously transmitted to the field construction modules, and each of the processed raw images is rescaled to a field. The Fieldscale provides accurate pixel correspondence in high-contrast images and may also be integrated into an online spatial bias correction pipeline by receiving a bias correction result.

Based on the systematic configuration as described above, real-time high-quality conversion is implemented, and experiments are conducted to assess whether information loss is reduced and recognition performance is improved. Specifically, after performing quantitative and qualitative image quality assessments, impact of two adjustable parameters is analyzed.

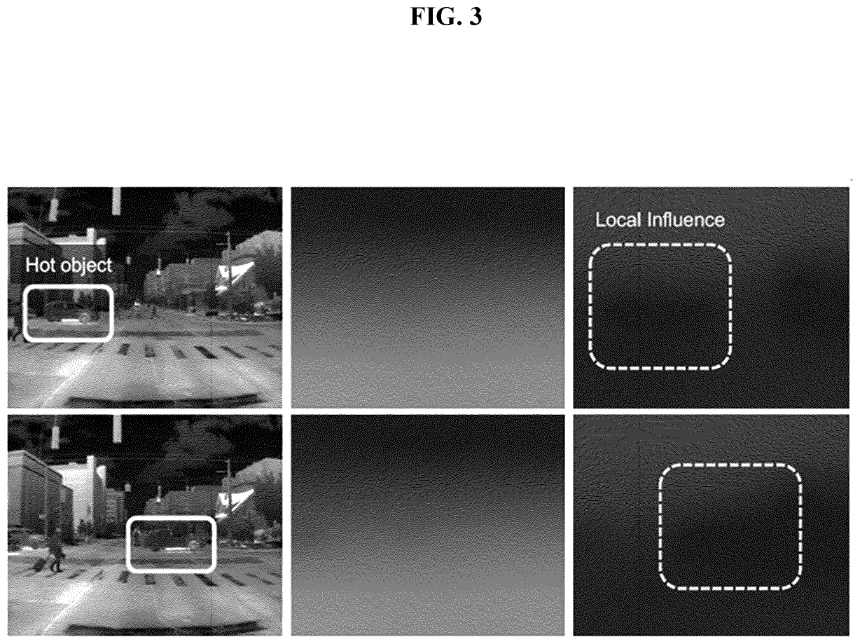

FIG. 3 is a view showing the results of qualitatively assessing locality-aware field-based thermal image enhancement according to the present disclosure.

Referring to FIG. 3, spatial adaptive characteristics of Fieldscale that captures a moving hot object from a stationary vehicle waiting for a traffic signal are qualitatively assessed. When there is no change in the intensity of the minimum field, it means that processing hot and cold areas is separated. Hot objects increase only the corresponding area of the maximum field, and the other areas of the image are not updated. That is, each pixel value in a rescaled image is determined only by neighboring pixel values. Owing to locality, an image rescaled with minimal detail loss can be generated in all areas by successfully performing high spatial temperature variance. In short, a process of matching a two-dimensional scalar field to a localized heat source is confirmed. As only the field values in an area where a strong heat source occurs are affected and the other areas are preserved, local thermal information can be reflected without loss of details.

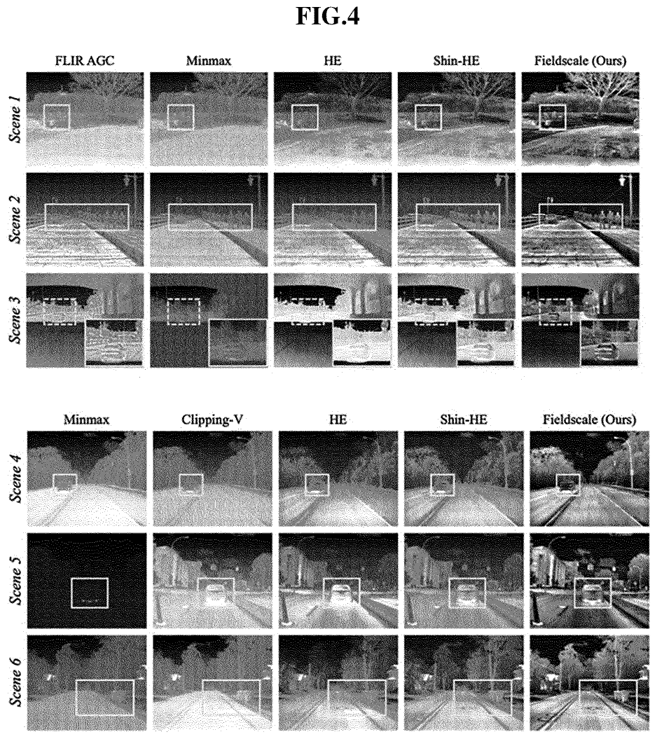

FIG. 4 is a view showing the results of quantitatively assessing locality-aware field-based thermal image enhancement according to the present disclosure.

Referring to FIG. 4, although there are several image quality assessment (IQA) criteria for evaluating the image level in the RGB domain, many of them are either a full-reference approach that should compare 8-bit images or a neural network-based method trained with RGB images. Accordingly, various image quality assessment criteria are utilized to comprehensively compare no-reference IQA metrics (slope and entropy) obtained from low illumination vision assessment with 14-bit raw images and 8-bit rescaled images. Specifically, global contrast loss (Cglobal), local contrast loss (Clocal), and tone mapping quality index (TMQI) are measured for rescaling. The TMQI quantifies measurements of multi-scale structural fidelity and statistical naturalness.

IQA is performed on three different sequences including validation images of FLIR ADAS dataset (FLIR-Val), RO-FAO daytime sequences of NSAVP dataset (NSAVP-Day), and campus nighttime sequences of ViViD++dataset (ViViD-Night). All three sequences are captured at different times and locations with different camera models (FLIR Tau2, Boson, and A65, respectively) and provide possibility of generalization of IQA results. All frames of the FLIR-Val are used, and both the NSAVP-Day and ViViD-Night are subsampled so that each frame is 10 m apart from the other frames. The baseline rescaling methods may be classified into FLIR AGC: AGC result of FUR software; Minmax: Linear AGC (automatic gain control) using global min/max values; Clipping-I: Clipping with 1% and 99% percentile values of the image; Clipping-V: Clipping with average 1% and 99% percentile values of all images in the video; Shin-HE: modified version and CLAHE of histogram equalization having a 30-bin size; MSR: Multiscale Retinex using σ=[15, 80, 250]; CGF: Clipping with a 3σ value of the image after conditional Gaussian filtering; and JointTMO: Joint rescaling and denoising based on a DNN trained with 8-bit reference-optimized MSR images. CGF is faithfully reimplemented, and JointTMO is evaluated with trained weights provided by the authors. FLIR-AGC can be used only for the FLIR-Val, and Clipping-I is not included in non-video sequences. N=7 and T_{LES}=100 are used in the Fieldscale (the present disclosure).

As a result, the FLIR AGC and Shin-HE may preserve edge information, but may also suffer from insufficient contrast or saturation of local details. The JointTMO shows boosted edge features and dark halos at the foreground-background boundaries, which are typical features of MSR-based approaches. It also shows relatively low naturalness as is known from the high global contrast and low TMQI. The Fieldscale shows the best or second-best result in all datasets. It may generate images having high contrast, natural appearance, and local details preserved by radiometric measurements at all critical spatial locations.

All metrics are primarily affected by iteration N, and T_{LES} adjusts sensitivity to iteration N. For example, the higher the T_{LES}, the more sensitive the gradient to iteration N. The tradeoff relationship between the contrast loss and the TMQI is observed. Here, parameters that generates the most natural images having a high TMQI may reduce the image contrast. Since the worst gradient, entropy, and contrast loss still show a result further better than those of most baselines, parameters that produce the best TMQI scores for each downstream task are selected. The training datasets of the two tasks show the highest scores of N=7 and T_{LES}=100, and the other values of the experiment are fixed according thereto.

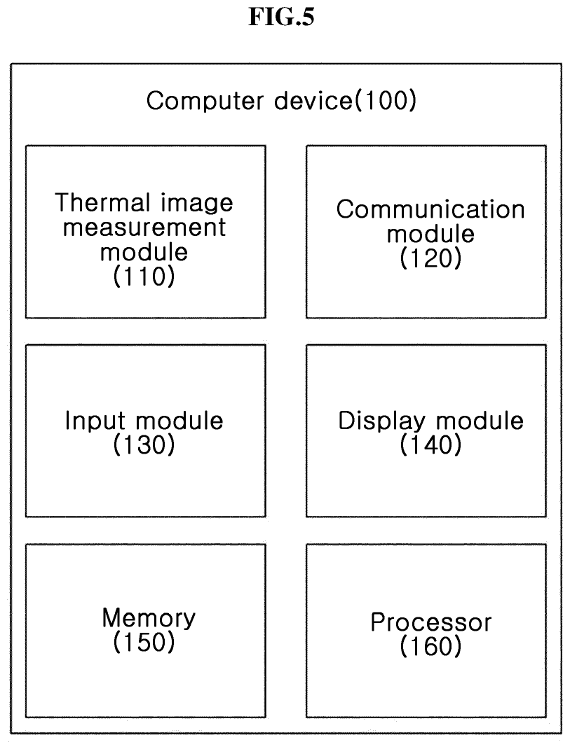

FIG. 5 is a view showing a computer device 100 for locality-aware field-based thermal image enhancement according to the present disclosure.

Referring to FIG. 5, the computer device 100 is for locality-aware field-based thermal image enhancement, and may include at least one among a thermal image measurement module 110, a communication module 120, an input module 130, a display module 140, a memory 150, or a processor 160. In some embodiments, at least one among the components of the computer device 100 (e.g., the thermal image measurement module 110, the communication module 120, the input module 130, and the display module 140) may be omitted. In some embodiments, at least one other component (e.g., a camera module, a sensor module) may be added in the computer device 100.

The thermal image measurement module 110 may be provided so that the computer device 100 may capture surrounding environments. The thermal image measurement module 110 may acquire thermal images. Specifically, the thermal image measurement module 110 may acquire thermal images having a predetermined pixel depth, i.e., a first pixel depth.

Through the communication module 120, the computer device 100 may perform communication with external devices (not shown). The communication module 120 may establish a communication channel between the computer device 100 and an external device, and perform communication with the external device through the communication channel. The communication module 120 may include at least any one among a wired communication module and a wireless communication module. For example, the wireless communication module may perform communication with the external device through at least any one among a wide area network and a local area network.

The input module 130 may input instructions to be used in at least one component of the computer device 100. The input module 130 may include at least any one among an input unit configured to allow a user to directly input instructions or data into the computer device 100, and a sensor unit configured to sense the surrounding environment and generate data. For example, the input unit may include at least any one among a microphone, a mouse, and a keyboard. In some embodiments, the input unit may include at least any one among a touch circuitry set to detect a touch and a sensor circuitry set to measure intensity of a force generated by the touch.

The display module 140 may visually output information to the outside of the computer device 100. For example, the display module 140 may include at least any one among a display, a holographic device, and a projector. In some embodiments, the display module 140 may by combined with at least one among the touch circuitry and the sensor circuitry of the input module 130 to be implemented as a touchscreen.

The memory 150 may store various data used by at least one component of the computer device 100. For example, the memory 150 may include at least any one among volatile memory and non-volatile memory. The data may include input data or output data for a program or instructions related thereto. The program may be stored in the memory 150 as software and may include at least any one among an operating system, middleware, and applications.

The processor 160 may control at least one component of the computer device 100 by executing a program in the memory 150. Through this, the processor 160 may perform data processing or calculations. At this point, the processor 160 may execute the instructions stored in the memory 150.

In various embodiments, the processor 160 may be provided for locality-aware field-based thermal image enhancement. To this end, the processor 160 may include a grid-wise min/max pooling module, a local extrema suppression module, a message passing module, and a bilinear interpolation module. At this point, the processor 160 may simultaneously improve a plurality of thermal images by processing them in parallel.

The processor 160 may construct a two-dimensional field from a thermal image having a first pixel depth, i.e., the local heat distribution of the first thermal image. In an embodiment, the first thermal image may be directly detected through the thermal image measurement module 110. In another embodiment, the first thermal image may be received from an external device through the communication module 120 or the input module 130. For example, the first pixel depth may be 14 bits or 16 bits. Specifically, the grid-wise min/max pooling module, the local extrema suppression module, and the message passing module may construct a two-dimensional field from the local heat distribution of the first thermal image.

The grid-wise min/max pooling module may divide a thermal image into a plurality of grids. Then, the grid-wise min/max pooling module may extract a minimum value and a maximum value of temperature at each of the grids. Accordingly, the grid-wise min/max pooling module may form a minimum grid and a maximum grid by combining the minimum values and the maximum values of the grids, respectively.

The local extrema suppression module compares the maximum value of each grid in the maximum grid with the average value of the maximum values of other grids within a predetermined distance from the grid, and adjusts the maximum value of at least one among the grids for the maximum grid through local extrema suppression as needed. More specifically, when the difference between the maximum value of one grid and the average value of the maximum values of other grids within a predetermined distance from that grid exceeds a threshold value in the maximum grid, the local extrema suppression module may adjust the maximum value of the grid as a combination of the average value and the threshold value. Here, the local extrema suppression module may repeat the local extrema suppression as many as a predetermined number of times, for example, N times. That is, the local extrema suppression module may determine whether or not to apply local extrema suppression to all grids of the maximum grid as many as a predetermined number of times, and apply local extrema suppression as needed in each iteration. At this point, the local extrema suppression module may apply the local extrema suppression as shown in [Equation 1]. That is, when the maximum value of the grid is smaller than the difference obtained by subtracting the threshold value from the average value, the local extrema suppression module may adjust the maximum value of the grid to the difference. On the other hand, when the maximum value of the grid exceeds the sum of the average value and the threshold value, the local extrema suppression module may adjust the maximum value of the grid to the sum. On the other hand, the local extrema suppression module may maintain the maximum value of the grid in all other cases.

The message passing module may construct the minimum field and the maximum field from the minimum grid and the maximum grid through message exchange between adjacent grids in each of the minimum grid and the maximum grid. Here, the message passing module may repeat message exchange as many as a predetermined number of times, for example, N times. That is, the message exchange module may repeat message exchange between adjacent grids in each of the minimum grid and the maximum grid as many as a predetermined number of times. At this point, the message passing module may update the minimum value and the maximum value of each grid in each iteration by using the aggregation function (Agg) and the update function (Update) as shown in [Equation 2].

The processor 160 may convert the first thermal image into a thermal image having a second pixel depth smaller than the first pixel depth, i.e., a second thermal image, using the two-dimensional field. For example, the second pixel depth may be 8 bits. Specifically, the first thermal image may be converted into the second thermal image using the two-dimensional field, which is a bilinear interpolation module.

The bilinear interpolation module may expand the minimum field and the maximum field to the resolution of the first thermal image through bilinear interpolation, respectively. Then, the bilinear interpolation module may convert each pixel of the thermal image having the first pixel depth into each pixel of the second thermal image using the minimum field and the maximum field. At this point, the bilinear interpolation module may operate on the basis of [Equation 3]. In [Equation 3], I represents the first thermal image, O represents the second thermal image, Φₘᵢₙ represents the minimum field, Φₘₐₓ represents the maximum field, and (x, y) represents the position of each pixel.

Additionally, the processor 160 may enhance the second thermal image by applying at least one among contrast enhancement, sharpening, deblurring, and non-uniform bias correction to the second thermal image.

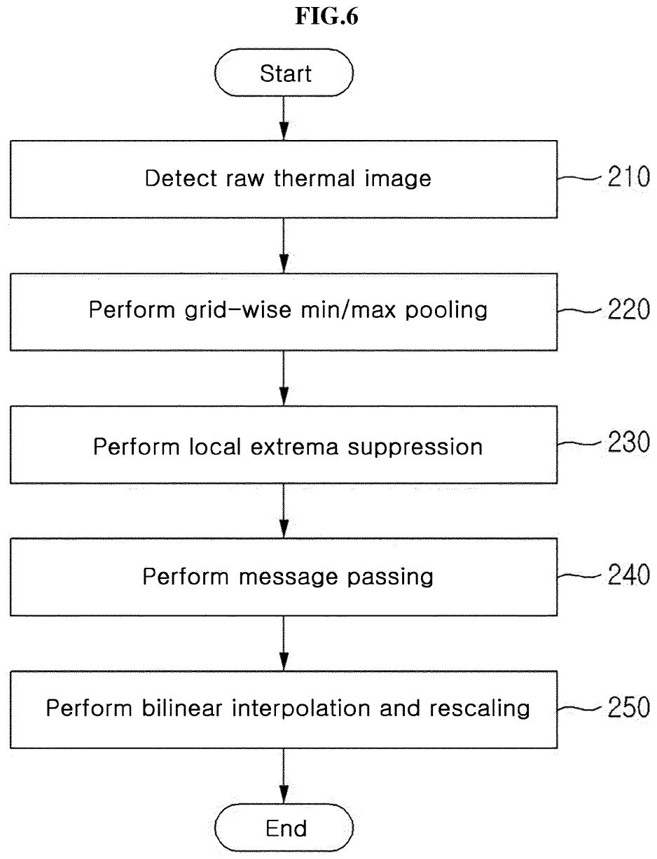

FIG. 6 is a flowchart illustrating an operation method of a computer device 100 for locality-aware field-based thermal image enhancement according to the present disclosure.

Referring to FIG. 6, the processor 160 may be provided for locality-aware field-based thermal image enhancement. To this end, the processor 160 may include a grid-wise min/max pooling module, a local extrema suppression module, a message passing module, and a bilinear interpolation module. At this point, the processor 160 may simultaneously improve a plurality of thermal images by processing them in parallel.

First, at step 210, the processor 160 may detect a raw thermal image. The raw thermal image may have a first pixel depth, and may also be referred to as a first thermal image. In an embodiment, the first thermal image may be directly detected through the thermal image measurement module 110. In another embodiment, the first thermal image may be received from an external device through the communication module 120 or the input module 130. For example, the first pixel depth may be 14 bits or 16 bits.

Next, at steps 220 to 240, the processor 160 may construct a two-dimensional field from the local heat distribution of the first thermal image. Specifically, the grid-wise min/max pooling module, the local extrema suppression module, and the message passing module may construct a two-dimensional field from the local heat distribution of the first thermal image.

At step 220, the processor 160 may perform grid-wise min/max pooling. Specifically, the grid-wise min/max pooling module may divide a thermal image into a plurality of grids. Then, the grid-wise min/max pooling module may extract a minimum value and a maximum value of temperature at each of the grids. Accordingly, the grid-wise min/max pooling module may form a minimum grid and a maximum grid by combining the minimum values and the maximum values of the grids, respectively.

Next, at step 230, the processor 160 may perform local extrema suppression. Specifically, the local extrema suppression module compares the maximum value of each grid in the maximum grid with the average value of the maximum values of other grids within a predetermined distance from the grid, and adjusts the maximum value of at least one among the grids for the maximum grid through local extrema suppression as needed. More specifically, when the difference between the maximum value of one grid and the average value of the maximum values of other grids within a predetermined distance from that grid exceeds a threshold value in the maximum grid, the local extrema suppression module may adjust the maximum value of the grid as a combination of the average value and the threshold value. Here, the local extrema suppression module may repeat the local extrema suppression as many as a predetermined number of times, for example, N times. That is, the local extrema suppression module may determine whether or not to apply local extrema suppression to all grids of the maximum grid as many as a predetermined number of times, and apply local extrema suppression as needed in each iteration. At this point, the local extrema suppression module may apply the local extrema suppression as shown in [Equation 1]. That is, when the maximum value of the grid is smaller than the difference obtained by subtracting the threshold value from the average value, the local extrema suppression module may adjust the maximum value of the grid to the difference. On the other hand, when the maximum value of the grid exceeds the sum of the average value and the threshold value, the local extrema suppression module may adjust the maximum value of the grid to the sum. On the other hand, the local extrema suppression module may maintain the maximum value of the grid in all other cases.

Continuously, at step 240, the processor 160 may perform message passing. Specifically, the message passing module may construct the minimum field and the maximum field from the minimum grid and the maximum grid through message exchange between adjacent grids in each of the minimum grid and the maximum grid. Here, the message passing module may repeat message exchange as many as a predetermined number of times, for example, N times. That is, the message exchange module may repeat message exchange between adjacent grids in each of the minimum grid and the maximum grid as many as a predetermined number of times. At this point, the message passing module may update the minimum value and the maximum value of each grid in each iteration by using the aggregation function (Agg) and the update function (Update) as shown in [Equation 2].

Finally, at step 250, the processor 160 may perform bilinear interpolation and rescaling. That is, the processor 160 may convert the first thermal image into a thermal image having a second pixel depth smaller than the first pixel depth, i.e., a second thermal image, using the two-dimensional field. For example, the second pixel depth may be 8 bits. Specifically, the first thermal image may be converted into the second thermal image using the two-dimensional field, which is a bilinear interpolation module.

The bilinear interpolation module may expand the minimum field and the maximum field to the resolution of the first thermal image through bilinear interpolation, respectively. Then, the bilinear interpolation module may convert each pixel of the thermal image having the first pixel depth into each pixel of the second thermal image using the minimum field and the maximum field. At this point, the bilinear interpolation module may operate on the basis of [Equation 3]. In [Equation 3], I represents the first thermal image, O represents the second thermal image, Φₘᵢₙ represents the minimum field, Φₘₐₓ represents the maximum field, and (x, y) represents the position of each pixel.

Additionally, the processor 160 may enhance the second thermal image by applying at least one among contrast enhancement, sharpening, deblurring, and non-uniform bias correction to the second thermal image.

The technique of the present disclosure may minimize contrast degradation and detail loss occurring due to a strong localized heat source by constructing a two-dimensional scalar field in a size the same as that of the image. As the technique of the present disclosure may demonstrate consistent performance in various environments without separate prior information or sensitive parameter settings, real-time performance and scalability thereof may be excellent. Owing to these characteristics, the technique of the present disclosure may significantly contribute to enhancement of the accuracy of subsequent tasks such as object detection, location recognition, and the like.

As a result, the technique of the present disclosure may easily enter the market as separate prior information is not required. In addition, as the technique of the present disclosure does not have hardware limitations, and compatibility of software with various thermal imaging cameras is excellent, it can be easily applied to mass production and industries. In addition, as the technique of the present disclosure can be easily expanded in parallel with additional image enhancement modules, it is expected to be highly demanded from manufacturers of thermal imaging cameras, such as FLIR and the like, and autonomous driving solution providers. In short, the technique of the present disclosure can be utilized in various industrial fields and technical application fields. It may enhance performance of object detection and location recognition of autonomous vehicles. It may improve the environmental awareness and obstacle avoidance capabilities of robots and drones. It may maximize the effect of video surveillance and security systems in nighttime and low illumination environments. It may also provide high-quality image information in specialized fields of military and disaster relief.

The device described above may be implemented as hardware components, software components, and/or a combination of hardware components and software components. For example, the devices and components described in the embodiments may be implemented using one or more general-purpose or special-purpose computers, such as a processor, a controller, an arithmetic logic unit (ALU), a digital signal processor, a microcomputer, a field programmable gate array (FPGA), a programmable logic unit (PLU), a microprocessor, and any other device capable of executing and responding to instructions. A processing device may execute the operating system (OS) and one or more software applications executed on the operating system. In addition, the processing device may access, store, manipulate, process, and generate data in response to execution of the software. Although there are cases of describing that a single processing device is used for easy understanding, those skilled in the art may understand that the processing device includes a plurality of processing elements and/or processing elements of a plurality of types. For example, the processing device may include a plurality of processors or one processor and one controller. In addition, other processing configurations, such as parallel processors, are possible.

The software may include computer programs, codes, instructions, or a combination of one or more of these, and may configure processing units to operate as desired or may command the processing units independently or collectively. The software and/or data may be embodied in any type of machine, component, physical device, or computer storage medium or device to be interpreted by the processing device or to provide instructions or data to the processing device. The software may be distributed to computer systems connected through a network to be stored or executed in a distributed manner. The software and data may be stored in one or more computer-readable recording media.

Methods according to various embodiments may be implemented in the form of program instructions that can be executed through various computer means and recorded in a computer-readable medium. At this point, the medium may continuously store programs that can be executed by a computer, or temporarily store the programs to execute or download. In addition, the medium may be a variety of recording or storage means in the form of a single piece of hardware or a combination of several pieces of hardware, and is not limited to a medium directly connected to a computer system, but may also be distributed on a network in a distributed manner. Examples of the medium may be those configured to store program instructions, including magnetic media such as hard disks, floppy disks, and magnetic tapes, optical recording media such as CD-ROMs and DVDs, magneto-optical media such as floptical disks, ROM, RAM, flash memory, and the like. In addition, other examples of the medium include various recording media or storage media managed by app stores that distribute applications, or various other sites, servers, or the like that supply or distribute software.

Various embodiments of this document and terms used herein are not intended to limit the techniques described in this document to specific embodiments, and should be understood to include various changes, equivalents, and/or substitutes of the corresponding embodiments. In relation to the description of drawings, similar reference numerals may be used for similar components. Singular expressions may include plural expressions, unless the context clearly dictates otherwise. In this document, expressions such as “A or B”, “at least one among A and/or B”, “A, B or C”, or “at least one among A, B and/or C” may include all possible combinations of items listed together. Expressions such as “a first”, “a second”, “the first”, “the second”, and the like may modify corresponding components regardless of the order or importance, and are used only to distinguish one component from another and do not limit corresponding components. When a component (e.g., a first component) is mentioned to be “(functionally or communicatively) connected” or “coupled” to another component (e.g., a second component), the component may be connected to another component directly or through still another component (e.g., a third component).

The term “module” used in this document includes units configured of hardware, software, or firmware, and may be interchangeably used together with the terms such as logic, logic blocks, parts, circuits, and the like. The module may be an integrated part, a minimum unit that performs one or more functions, or a part thereof. For example, the module may be configured as an application-specific integrated circuit (ASIC).

According to various embodiments, each component (e.g., module or program) among the components described above may include a single entity or a plurality of entities. According to various embodiments, one or more of the components or steps described above may be omitted, or one or more other components or steps may be added. In substitution or addition, a plurality of components (e.g., modules or programs) may be integrated into a single component. In this case, the integrated component may perform one or more functions of each of the plurality of components in a manner the same as or similar to those performed by a corresponding component of the plurality of components prior to integration. According to various embodiments, the steps performed by the modules, programs, or other components may be executed sequentially, in parallel, iteratively, or heuristically, or one or more of the steps may be executed in a different order or omitted, or one or more other steps may be added.

The technique of the present disclosure may minimize contrast degradation and detail loss occurring due to a strong localized heat source by constructing a two-dimensional scalar field in a size the same as that of the image. As the technique of the present disclosure may demonstrate consistent performance in various environments without separate prior information or sensitive parameter settings, real-time performance and scalability thereof may be excellent. Owing to these characteristics, the technique of the present disclosure may significantly contribute to enhancement of the accuracy of subsequent tasks such as object detection, location recognition, and the like.

What is claimed is:

1. An operation method of a computer device for locality-aware field-based thermal image enhancement, the method comprising the steps of:
constructing a two-dimensional field from a local heat distribution of a thermal image having a first pixel depth; and
converting the thermal image into a thermal image having a second pixel depth smaller than the first pixel depth using the two-dimensional field.

2. The method according to claim 1, wherein the step of constructing a two-dimensional field includes the steps of:
dividing the thermal image into a plurality of grids and extracting a minimum value and a maximum value of temperature at each of the grids to form a minimum grid and a maximum grid by combining the minimum values and the maximum values of the grids;
adjusting, when a difference between the maximum value of one grid and an average value of the maximum values of grids within a predetermined distance from that grid exceeds a threshold value in the maximum grid, the maximum value of at least one among the grids for the maximum grid through local extrema suppression that adjusts the maximum value of the grid as a combination of the average value and the threshold value; and
constructing a minimum field and a maximum field from the minimum grid and the maximum grid through message exchange between adjacent grids in each of the minimum grid and the maximum grid.

3. The method according to claim 2, wherein the step of converting the thermal image into a thermal image having a second pixel depth includes the steps of:
expanding the minimum field and the maximum field to a resolution of the thermal image having the first pixel depth through bilinear interpolation; and
converting each pixel of the thermal image having the first pixel depth into each pixel of the thermal image having the second pixel depth using the minimum field and the maximum field.

4. The method according to claim 3, wherein the step of converting each pixel of the thermal image having the first pixel depth into each pixel of the thermal image having the second pixel depth is performed according to an equation shown below,
$$O ( x , y ) = 255 \times \frac{I ( x , y ) - {∅}_{min} ( x , y )}{{∅}_{max} ( x , y ) - {∅}_{min} ( x , y )}$$
wherein I represents the thermal image having the first pixel depth, O represents the thermal image having the second pixel depth, Φₘᵢₙ represents the minimum field, Φₘₐₓ represents the maximum field, and (x, y) represents a position of each pixel.

5. The method according to claim 2, wherein at least one among the local extrema suppression or the message exchange is repeated as many as a predetermined number of times.

6. The method according to claim 2, wherein the local extrema suppression adjusts, when the maximum value of the grid is smaller than a difference obtained by subtracting the threshold value from the average value, the maximum value of the grid to the difference, adjusts, when the maximum value of the grid exceeds a sum of the average value and the threshold value, the maximum value of the grid to the sum, and maintains the maximum value of the grid in other cases.

7. The method according to claim 2, further comprising the step of enhancing the thermal image having the second pixel depth by applying at least one among contrast enhancement, sharpening, deblurring, and non-uniform bias correction to the thermal image having the second pixel depth.

8. The method according to claim 1, wherein the first pixel depth is 14 bits or 16 bits, and the second pixel depth is 8 bits.

9. A computer device for locality-aware field-based thermal image enhancement, the device comprising:
a memory; and
a processor connected to the memory and configured to execute at least one instruction stored in the memory, wherein
the processor is configured to construct a two-dimensional field from a local heat distribution of a thermal image having a first pixel depth, and convert the thermal image into a thermal image having a second pixel depth smaller than the first pixel depth using the two-dimensional field.

10. The device according to claim 9, wherein the processor is configured to divide the thermal image into a plurality of grids and extracting a minimum value and a maximum value of temperature at each of the grids to form a minimum grid and a maximum grid by combining the minimum values and the maximum values of the grids, adjust, when a difference between the maximum value of one grid and an average value of the maximum values of grids within a predetermined distance from that grid exceeds a threshold value in the maximum grid, the maximum value of at least one among the grids for the maximum grid through local extrema suppression that adjusts the maximum value of the grid as a combination of the average value and the threshold value, and construct a minimum field and a maximum field from the minimum grid and the maximum grid through message exchange between adjacent grids in each of the minimum grid and the maximum grid.

11. The device according to claim 10, wherein the processor is configured to expand the minimum field and the maximum field to a resolution of the thermal image having the first pixel depth through bilinear interpolation, and convert each pixel of the thermal image having the first pixel depth into each pixel of the thermal image having the second pixel depth using the minimum field and the maximum field.

12. The device according to claim 11, wherein the processor is configured to convert each pixel of the thermal image having the first pixel depth into each pixel of the thermal image having the second pixel depth using the minimum field and the maximum field according to an equation shown below,
$$O ( x , y ) = 255 \times \frac{I ( x , y ) - {∅}_{min} ( x , y )}{{∅}_{max} ( x , y ) - {∅}_{min} ( x , y )}$$
wherein I represents the thermal image having the first pixel depth, O represents the thermal image having the second pixel depth, Φₘᵢₙ represents the minimum field, Φₘₐₓ represents the maximum field, and (x, y) represents a position of each pixel.

13. The device according to claim 10, wherein at least one among the local extrema suppression or the message exchange is repeated as many as a predetermined number of times.

14. The device according to claim 9, wherein the processor is configured to enhance the thermal image having the second pixel depth by applying at least one among contrast enhancement, sharpening, deblurring, and non-uniform bias correction to the thermal image having the second pixel depth.

15. A computer program stored in a non-transitory computer-readable recording medium to execute a locality-aware field-based thermal image enhancement method on a computer device, wherein
the thermal image enhancement method comprises the steps of:
constructing a two-dimensional field from a local heat distribution of a thermal image having a first pixel depth; and
converting the thermal image into a thermal image having a second pixel depth smaller than the first pixel depth using the two-dimensional field.
